(19) United States
(12) Patent Application Publication
(10) Pub. No.: US 2010/0289356 A1
(43) Pub. Date: Nov. 18, 2010

(54) MOTOR

(75) Inventors: Yoshihiro Kida, Nishio-shi (JP); Makoto Taniguchi, Oobu-shi (JP)

Correspondence Address: OLIFF & BERRIDGE, PLC, P.O. BOX 320850, ALEXANDRIA, VA, 22320-4850, US

(73) Assignees: NIPPON SOKEN, INC., Nishio-City (JP); DENSO CORPORATION, Kariya-City (JP)

(21) Appl. No.: 12/777,555

(22) Filed: May 11, 2010

(30) Foreign Application Priority Data
May 14, 2009 (JP) 2009-117959

(51) Int. Cl. H02K 3/28

(52) U.S. Cl. 310/71

(57) ABSTRACT

The present invention provides, as one aspect, a motor including a rotor fixed to a rotating shaft, a stator provided around the outer periphery of the rotor via a gap, and a power converter which is connected to polyphase windings arranged in slots formed in the stator. The power converter performs control by which current from a DC power source is converted to polyphase alternating current which flows to the polyphase windings. The motor includes a housing which is fixed to the outer periphery of the stator via an insulating layer. The stator is connected to a positive electrode side bus, which is connected to a positive electrode of the DC power source, or a negative electrode side bus, which is connected to a negative electrode of the DC power source.

### CROSS REFERENCE TO RELATED APPLICATION

This application is based on and claims the benefit of priority from earlier Japanese Patent Application No. 2009-117959 filed May 14, 2009, the description of which is incorporated herein by reference.

### BACKGROUND OF THE INVENTION

1. Technical Field of the Invention

The present invention relates to a motor which can reduce common mode current leaking from the motor to the ground.

2. Related Art

Conventionally, in a case where common mode current flows from a motor to the ground, electronic devices provided on the periphery of the motor malfunction due to radiation noise produced by the common mode current. To solve this problem, configurations have been considered in which the common mode current does not flow to the ground. One example is a power converter having a motor, which is disclosed in Japanese Patent No. 3716152. This power converter includes, as shown in FIG. 9, an AC power supply 1 (single phase or three phase), a rectifying circuit 2, a smoothing capacitor 3, a three-phase 2-level inverter 4a, a noise reduction circuit 6a, a control circuit 41, and a three-phase AC motor 5. The rectifying circuit 2 is connected to the AC power supply 1 and converts AC to DC. The smoothing capacitor 3 is connected between buses P and N for DC which are output lines of the rectifying circuit 2. The three-phase 2-level inverter 4a is connected to the buses P and N. The control circuit 41 is provided in the 2-level inverter 4a and produces a control signal for controlling the noise reduction circuit 6a. The three-phase AC motor 5, which is a load, is connected to the output side of the 2-level inverter 4a.

In the above configuration, a capacitor C2 between the neutral point of the stator coil of the motor 5 and a housing (which has ground potential) is charged and discharged, whereby leak current Io flows. The leak current Io circulates through a power line including a grounded system (ground E2 ground E1→→power supply 1), thereby producing common mode noise (common mode current). To solve this problem, the control circuit 41 of the 2-level inverter 4a turns on transistors Tp1 and Tn1 of the noise reduction circuit 6a for a predetermined time to output canceling current Ic so as to cancel the leak current Io. Thereby, ground current Ie becomes substantially 0, and the common mode noise also becomes substantially 0. In this manner, the common mode current is reduced.

According to the above Japanese Patent No. 3716152, the noise reduction circuit 6a is added to reduce the common mode current. However, adding the noise reduction circuit 6a increases the motor 5 in is size which includes circuits for driving the motor, and complicates the control of the motor. That is, increasing the motor in size complicates the control thereof.

### SUMMARY OF THE INVENTION

The present invention has been made in consideration of the foregoing conventional situation, and an object of the present invention is to provide a motor which can reduce common mode current flowing from a housing to the ground so as to prevent the motor from increasing in size and complicating the control thereof.

In order to achieve the object, the present invention provides, as one aspect, a motor including a rotor fixed to a rotating shaft, a stator provided around the outer periphery of the rotor via a gap, and a power converter which is connected to polyphase windings arranged in slots formed in the stator, and performs control by which current from a DC power source is converted to polyphase alternating current which flows to the polyphase windings, including: a housing which is fixed to the outer periphery of the stator via an insulating layer, wherein the stator is connected to a positive electrode side bus, which is connected to a positive electrode of the DC power source, or a negative electrode side bus, which is connected to a negative electrode of the DC power source.

### BRIEF DESCRIPTION OF THE DRAWINGS

In the accompanying drawings:

FIG. 1 is a diagram showing a configuration of a motor according to a first embodiment of the present invention;

FIGS. 2A and 2B are circuit diagrams of the motor including a power converter;

FIG. 3 is a diagram showing a configuration of a conventional motor, which corresponds to the motor according to the first embodiment;

FIG. 4 is a circuit diagram of the conventional motor including a power converter, which corresponds to the motor according to the first embodiment;

FIG. 5 is a diagram showing a configuration of a motor according to a second embodiment of the present invention;

FIG. 6 is a circuit diagram of the motor including a power converter;

FIG. 7 is a diagram showing a configuration of a conventional motor, which corresponds to the motor according to the second embodiment;

FIG. 8 is a circuit diagram of the conventional motor including a power converter, which corresponds to the motor according to the second embodiment; and

FIG. 9 is a diagram showing a configuration of a conventional power converter including a motor.

### DETAILED DESCRIPTION OF THE PREFERRED EMBODIMENTS

Hereinafter, embodiments of the present invention will now be described in connection with the accompanying drawings. In the embodiments set forth below, the components identical with or similar to each other are given the same reference numerals for the sake of omitting redundant explanation.

### First Embodiment

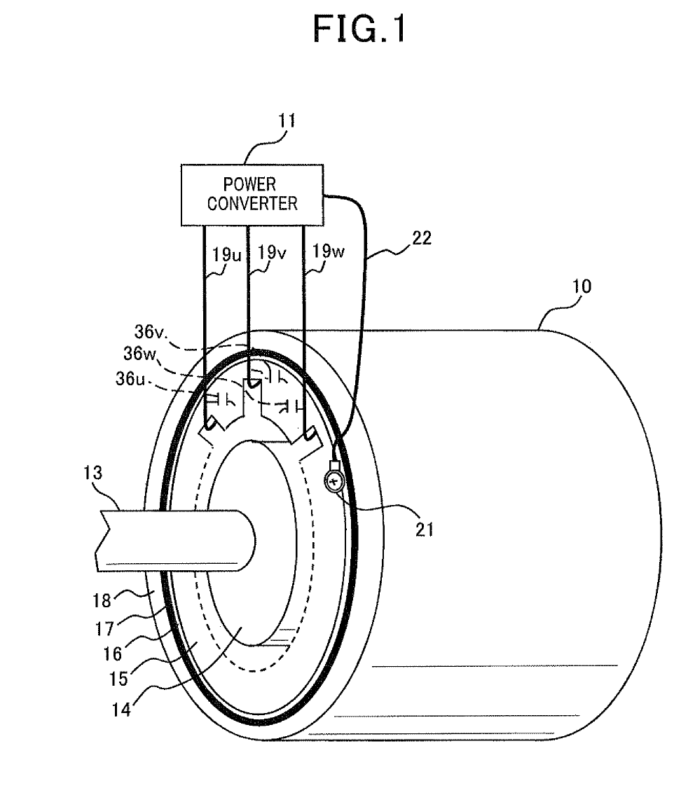

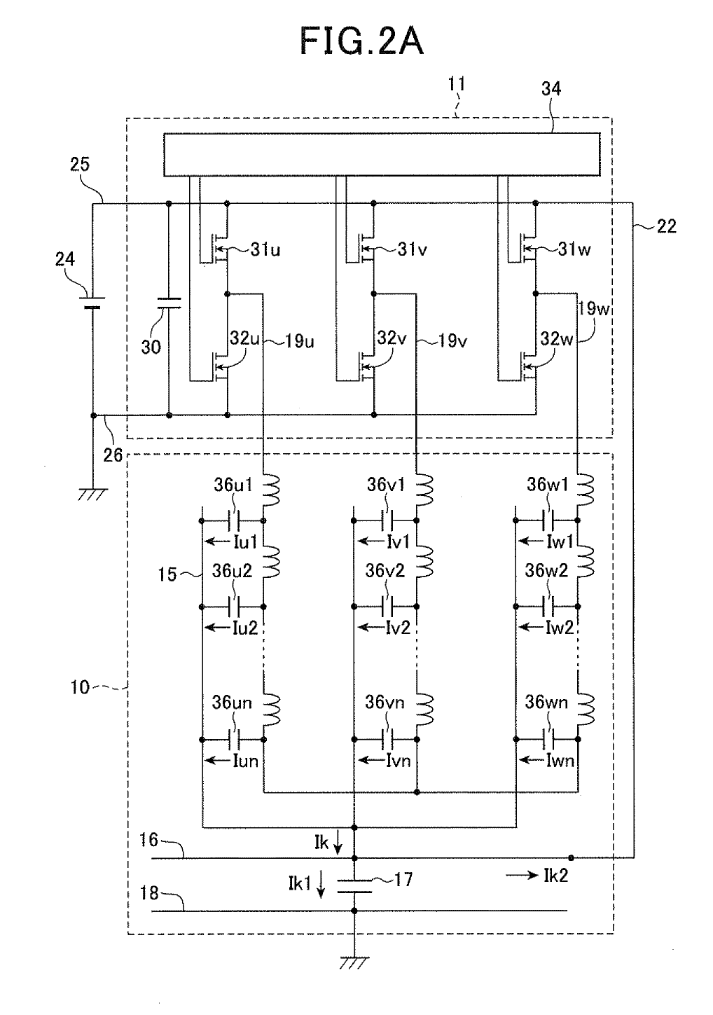

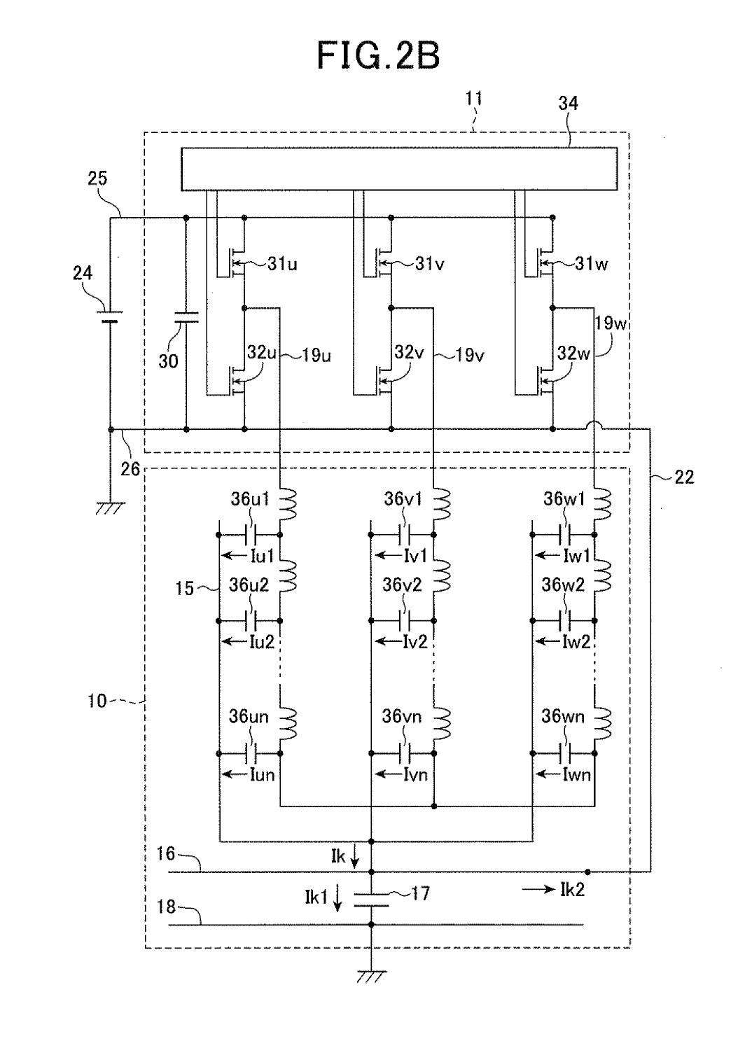

FIG. 1 is a diagram showing a configuration of a motor (motor system) according to a first embodiment of the present invention. FIG. 2A is a circuit diagram of the motor.

A motor 10 shown in FIG. 1 includes a power converter 11, a rotating shaft 13, a columnar rotor 14, a cylindrical stator 15, an inner housing 16, an insulating layer 17, and an outer housing 18. The rotor 14 is fixed to the rotating shaft 13. The stator 15 is provided around the outer periphery of the rotor 14 via a predetermined gap therebetween. The inner housing 16 is fixed to the outer periphery of the stator 15. The outer housing 18 is fixed to the outer periphery of the inner housing 16 via the insulating layer 17 therebetween. UVW-phase three-phase windings 19u, 19v and 19w are arranged in slots formed in the stator 15 and connected to the power converter 11. The inner housing 16 fixed to the stator 15 is connected to the power converter 11 via wiring 22 extending from a terminal 21 fixed to the stator 15. As shown in FIG. 2A, the inner housing 16 is connected to a positive electrode side bus 25 of the power converter 11, which is connected to the positive electrode of a DC power source 24, via the wiring 22. Note that the inner housing 16 is subject to shrink fitting to the stator 15, whereby the inner housing 16 is integral with the stator 15 in practice.

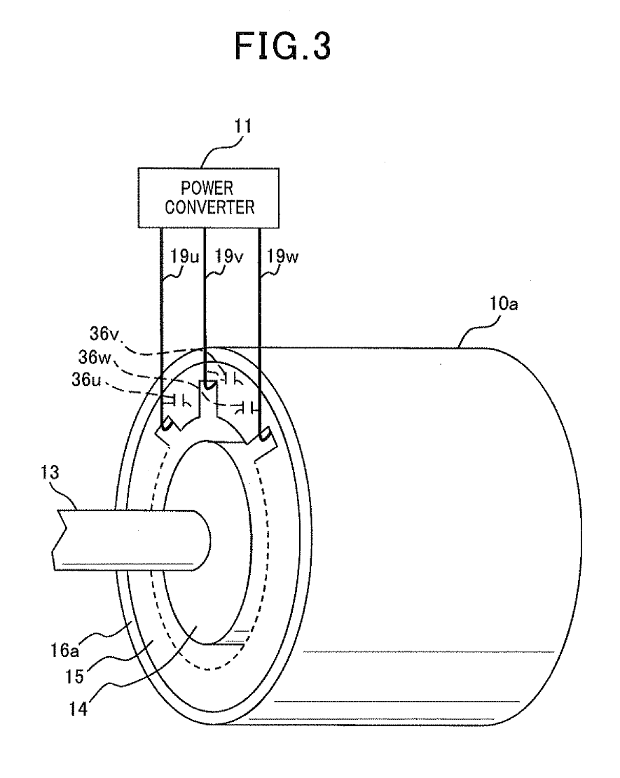

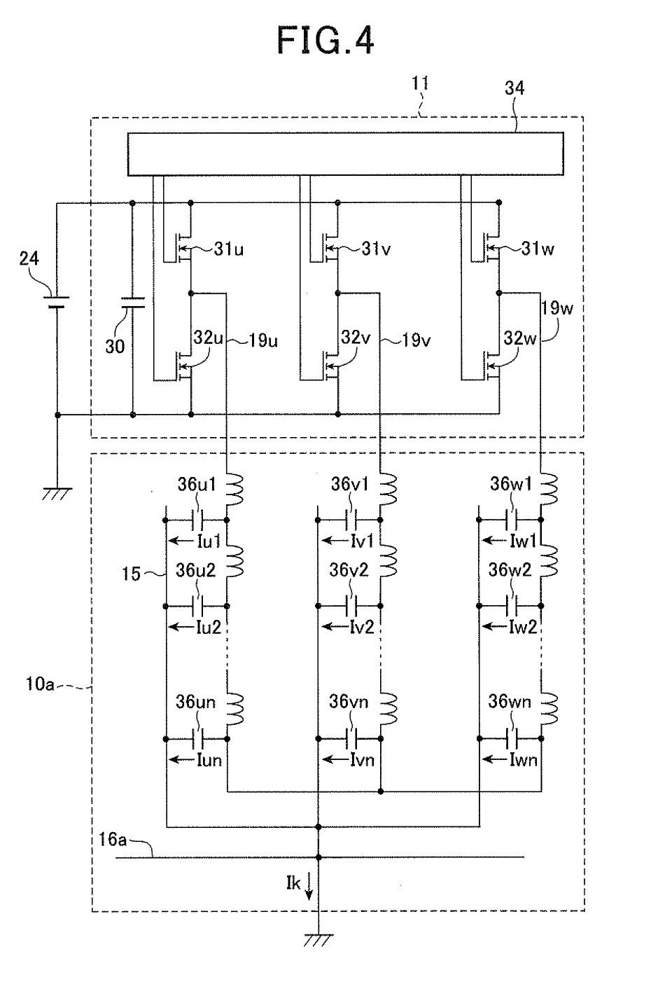

FIG. 3 shows a conventional motor, which corresponds to the motor 10 according to the first embodiment. FIG. 4 is a circuit diagram of the conventional motor. As shown in FIGS. 3 and 4, the conventional motor 10a does not have the insulating layer 17 and the outer housing 18, and the housing 16a is integrally fixed to the stator 15 by shrink fitting. In addition, the motor 10a has no wiring connecting the housing 16a, which is integral with the stator 15, with the positive electrode side bus 25 of the power converter 11.

That is, the motor 10 of the first embodiment is characterized in that the outer housing 18 is fixed to the outer periphery of the inner housing 16, which is integral with the outer periphery of stator 15, via the insulating layer 17, and the inner housing 16 is connected to the positive electrode side bus 25 of the power converter 11 via the wiring 22. Note that the inner housing 16 may be connected to a negative electrode side bus 26 via the wiring 22, as shown FIG. 2B.

The power converter 11 includes, as shown in FIG. 2A, a smoothing capacitor 30, three-phase upper arm power conversion elements 31u, 31v and 31w, and three-phase lower arm power conversion elements 32u, 32v and 32w. The upper arm power is conversion elements 31u, 31v and 31w and the lower arm power conversion elements 32u, 32v and 32w are respectively connected to each other via the upper arms and the lower arms. Each of the three-phase windings 19u, 19v and 19w is connected to each of the connecting portions between the upper arms and the lower arms. Furthermore, a control circuit 34 is connected to control terminals of the upper arm power conversion elements 31u, 31v and 31w and the lower arm power conversion elements 32u, 32v and 32w.

In FIG. 2A, reference numerals 36u1 to 36un, 36v1 to 36vn, and 36w1 to 36wn indicate circuits configured by stray capacitance 36u, 36v and 36w, shown in FIG. 1, between the three-phase windings 19u, 19v and 19w and the stator 15. The inner housing 16 is electrically connected to the outer housing 18 via the insulating layer 17 which can be equivalently expressed in stray capacitance. The outer housing 18 is grounded.

In the motor 10 described above, the control circuit 34 of the power converter 11 controls on/off switching operations of the upper arm power conversion elements 31u, 31v and 31w and the lower arm power conversion elements 32u, 32v and 32w. According to the operations, during a rising period or a falling period of rectangular waves of voltage applied to the three-phase windings 19u, 19v and 19w, leak current Iu1 to Iun, Iv1 to Ivn, and Iw1 to Iwn flows from the three-phase windings 19u, 19v and 19w to the stator 15 and the inner housing 16 via stray capacitance 36u1 to 36un, 36v1 to 36vn, and 36w1 to 36wn between the three-phase windings 19u, 19v and 19w and the stator 15.

The flowing leak current Ik is divided into leak current Ik1 and leak current Ik2. The leak current Ik1 flows from the inner housing 16 to the outer housing 18 via the insulating layer 17. The leak current Ik2 flows from the inner housing 16 to the positive electrode side bus 25 of the power converter 11 via the wiring 22.

In this case, the leak current Ik2 is large which flows from the inner housing 16 to the power converter 11 via the wiring 22. The leak current Ik2 flows from the positive electrode side bus 25 to the three-phase windings 19u, 19v and 19w via the upper arm power conversion elements 31u, 31v and 31w. Alternatively, the leak current Ik2 flows from the positive electrode side bus 25 to the lower arm power conversion elements 32u, 32v and 32w via the smoothing capacitor 30 or the DC power source 24, thereby flowing to the three-phase windings 19u, 19v and 19w. Therefore, the leak current Ik2 does not flow to the outer housing 18 of the motor 10. In addition, since the insulating layer 17 intervenes between the inner housing 16 and the outer housing 18, the leak current Ik1 does not flow or slightly flows to the ground. The current leaking from the outer housing 18 to the ground, i.e. the common mode current, is reduced so as to become extremely small or not to flow.

As described above, the motor 10 according to the first embodiment includes the rotor 14, the stator 15, and the power converter 11. The rotor 14 is fixed to the rotating shaft 13. The stator 15 is provided around the outer periphery of the rotor 14 via a predetermined gap therebetween. The power converter 11 is connected to the three-phase windings 19u, 19v and 19w arranged in the slots formed in the stator 15, and performs the control by which current from the DC power source 24 is converted to three-phase alternating current which flows to the three-phase windings 19u, 19v and 19w.

In the above motor 10, the outer housing 18 is fixed to the outer periphery of the stator 15 via the insulating layer 17. The stator 15 is connected to the positive electrode side bus 25, which is connected to the positive electrode of the DC power source 24 of the power converter 11, by wiring, as shown in FIG. 2A. Alternatively, the stator 15 is connected to the negative electrode side bus 26, which is connected to the negative electrode of the DC power source 24, by wiring, as shown in FIG. 2B.

According to the above configuration, when the three-phase alternating current converted in the power converter 11 flows to the is three-phase windings 19u, 19v and 19w, the leak current Ik1 flows from the three-phase windings 19u, 19v and 19w to the stator 15 via stray capacitance between the three-phase windings 19u, 19v and 19w and the stator 15. The flowing leak current Ik is divided into the leak current Ik1 and the leak current Ik2. The leak current Ik1 flows from the stator 15 to the outer housing 18 via the insulating layer 17. The leak current Ik2 flows from the stator 15 to the positive electrode side bus 25 (or the negative electrode side bus 26) of the power converter 11 via the wiring 22.

The large leak current Ik2, which flows from the stator 15 to the power converter 11 via the wiring 22, flows from the power converter 11 to the three-phase windings 19u, 19v and 19w. Alternatively, the leak current Ik2 flows from the power converter 11 to the three-phase windings 19u, 19v and 19w via the DC power source 24. That is, the leak current Ik2 does not flow to the outer housing 18 of the motor 10. Meanwhile, since the insulating layer 17 intervenes between the stator 15 and the outer housing 18, the leak current Ik1, which can flow from the stator 15 to the outer housing 18 via the insulating layer 17, does not flow or flows only slightly. Therefore, the current leaking from the outer housing 18 to the ground, i.e. the common mode current, is reduced so as to become extremely small or not to flow. In addition, the motor 10 according to the present embodiment does not require additional components such as a noise reduction circuit which is installed in conventional motors, which prevents the motor 10 including the power converter 11 from increasing in size and complicating the control thereof.

### Second Embodiment

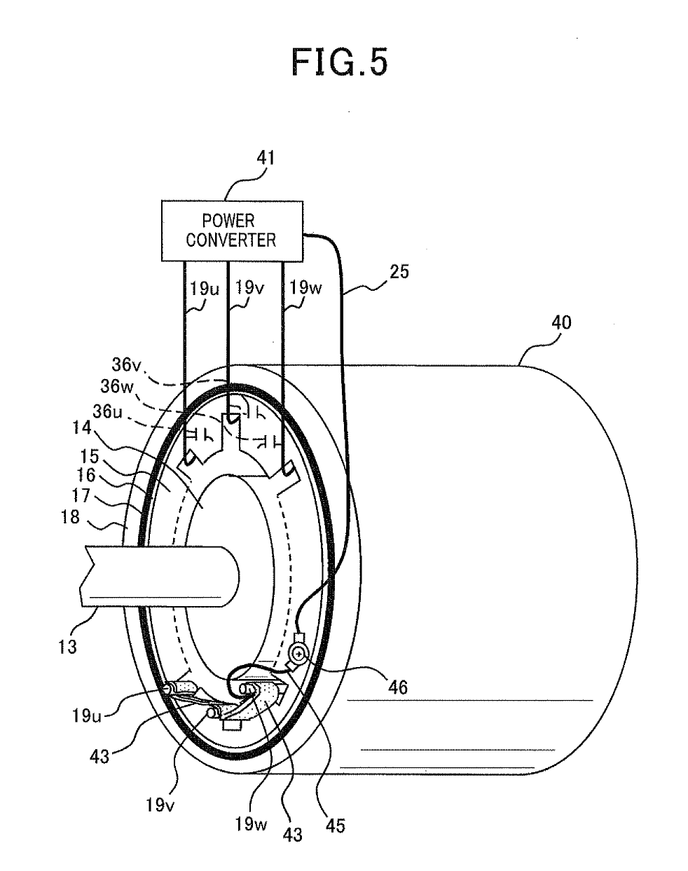

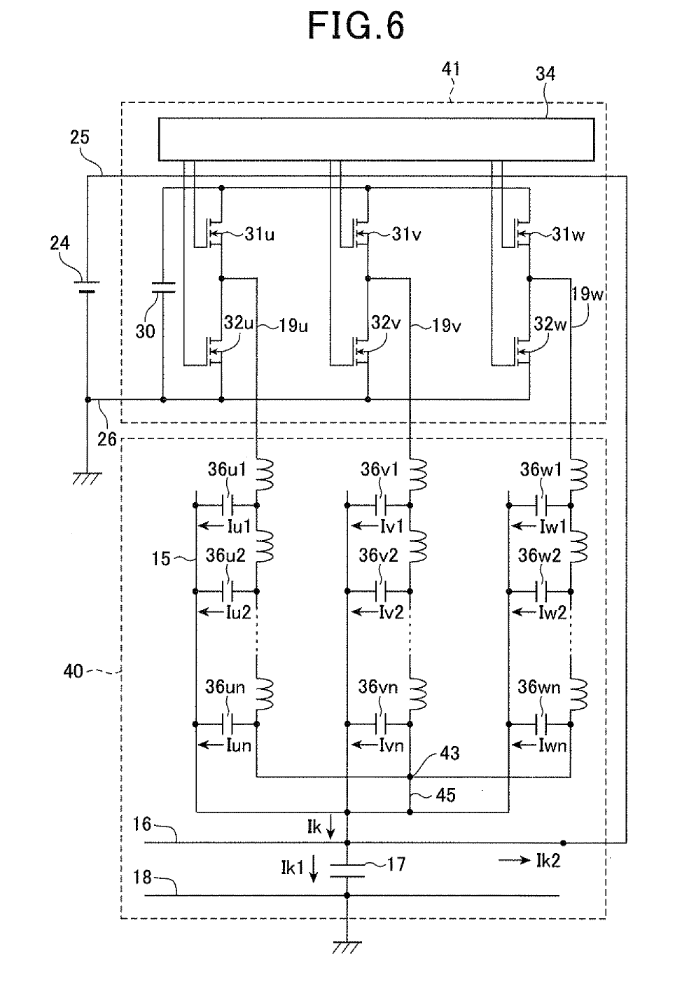

FIG. 5 is a diagram showing a configuration of a motor (motor system) according to a second embodiment of the present invention. FIG. 6 is a circuit diagram of the motor.

A motor 40 shown in FIG. 5 includes a power converter 41, the rotating shaft 13, the columnar rotor 14, the cylindrical stator 15, the inner housing 16, the insulating layer 17, and the outer housing 18. The rotor 14 is fixed to the rotating shaft 13. The stator 15 is provided around the outer periphery of the rotor 14 via a predetermined gap therebetween. The inner housing 16 is fixed to the outer periphery of the stator 15. The outer housing 18 is fixed to the outer periphery of the inner housing 16 via the insulating layer 17 therebetween. One ends of the UVW-phase three-phase windings 19u, 19v and 19w, which are arranged in slots formed in the stator 15, are connected to the power converter 41. The other ends (terminals) of the UVW-phase three-phase windings 19u, 19v and 19w are collectively connected to one another by a terminal connector 43. The terminal connector 43 is connected to the stator 15 via wiring 45 and a terminal 46 fixed to the stator 15. Furthermore, the inner housing 16 fixed to the stator 15 is connected to the positive electrode side bus 25, shown in FIG. 6, which is connected to the positive electrode of the DC power source 24 of the so power converter 41. Note that since the other ends of the three-phase windings 19u, 19v and 19w are collectively connected to one another by the terminal connector 43, the point at which the three-phase windings are collectively connected may be referred to as a neutral point (43).

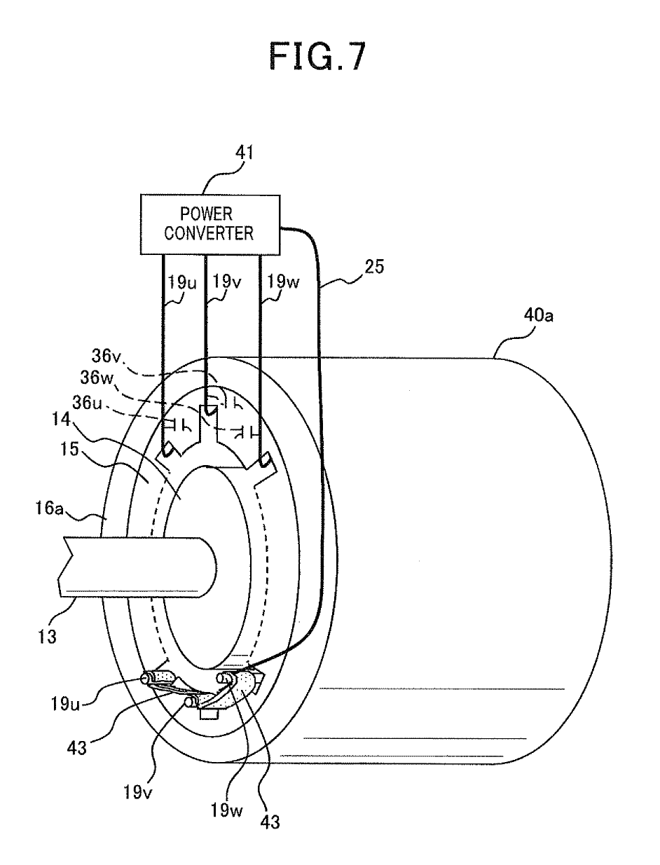

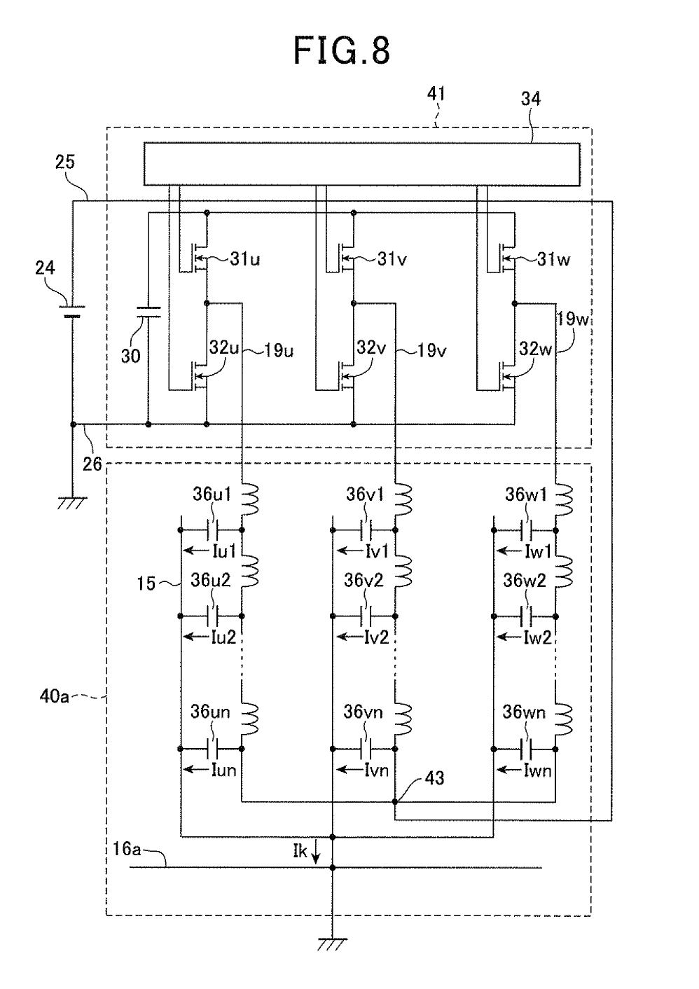

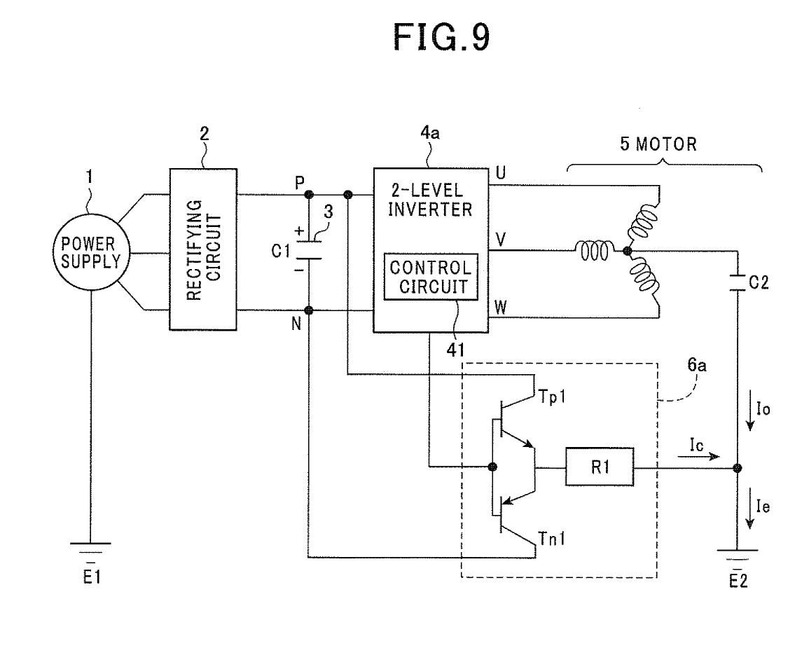

FIG. 7 shows a conventional motor, which corresponds to the motor 40 according to the second embodiment. FIG. 8 is a circuit diagram of the conventional motor. As shown in FIGS. 7 and 8, the conventional motor 40a does not have the insulating layer 17 and the outer housing 18, and the housing 16a is integrally fixed to the stator 15 by shrink fitting. In addition, the neutral point (43) and the positive electrode side bus 25 are directly connected with each other. That is, the motor 40a has no wiring connecting the housing 16a, which is integral with the stator 15, with the positive electrode side bus 25.

Hence, the motor 40 of the second embodiment is characterized in that the outer housing 18 is fixed to the outer periphery of the inner housing 16, which is integral with the outer periphery of stator 15, via the is insulating layer 17, the neutral point (43) of the three-phase windings 19u, 19v and 19w is connected to the stator 15 by using the wiring 45, and the inner housing 16 integral with the stator 15 is connected to the positive electrode side bus 25 of the power converter 41.

The power converter 41 includes, as shown in FIG. 6, the smoothing capacitor 30, three-phase upper arm power conversion elements 31u, 31v and 31w, and three-phase lower arm power conversion elements 32u, 32v and 32w. One end of the smoothing capacitor 30 is connected to the negative electrode of the DC power source 24. Between the other end of the smoothing capacitor 30 and the negative electrode side bus 26 connected to the negative electrode of the DC power source 24, the upper arm power conversion elements 31u, 31v and 31w and the lower arm power conversion elements 32u, 32v and 32w are respectively connected to each other via the upper arms and the lower arms. Each of the three-phase windings 19u, 19v and 19w is connected to each of the connecting portions between the upper arms and the lower arms. Furthermore, the control circuit 34 is connected to control terminals of the upper arm power conversion elements 31u, 31v and 31w and the lower arm power conversion elements 32u, 32v and 32w.

In the motor 40 described above, the control circuit 34 of the power converter 41 controls on/off switching operations of the upper arm power conversion elements 31u, 31v and 31w and the lower arm power conversion elements 32u, 32v and 32w. In the operations, during a rising period or a falling period of rectangular waves of voltage applied to the three-phase windings 19u, 19v and 19w, leak current Iu1 to run, Iv1 to Ivn, and Iw1 to Iwn flows from the three-phase windings 19u, 19v and 19w to the stator 15 and the inner housing 16 via stray capacitance 36u1 to 36un, 36v1 to 36vn, and 36w1 to 36wn between the three-phase windings 19u, 19v and 19w and the stator 15.

The flowing leak current Ik is divided into leak current Ik1 and leak current Ik2. The leak current Ik1 flows from the inner housing 16 to the outer housing 18 via the insulating layer 17. The leak current Ik2 flows from the inner housing 16 to the positive electrode side bus 25. Note that although the neutral point (43) is connected to the stator 15 via the wiring 45, components of the leak current Iu1 to Iun, Iv1 to Ivn, and Iw1 to Iwn are extremely small which flow from the stator 15 to the neutral point (43) due to coil components of the three-phase windings 19u, 19v and 19w.

In this case, the leak current Ik2 is large which flows from the inner housing 16 to the power converter 41. The leak current Ik2 flows from the positive electrode side bus 25 to the lower arm power conversion elements 32u, 32v and 32w via the DC power source 24. Furthermore, the leak current Ik2 flows from the lower arm power conversion elements 32u, 32v and 32w to the three-phase windings 19u, 19v and 19w. Therefore, the leak current Ik2 does not flow to the outer housing 18 of the motor 40. In addition, since the insulating layer 17 intervenes between the inner housing 16 and the outer housing 18, the leak current Ik1 does not flow or slightly flows to the ground. The current leaking from the outer housing 18 to the ground, i.e. the common mode current, is reduced so as to become extremely small or not to flow.

As described above, the motor 40 according to the second embodiment includes the rotor 14, the stator 15, and the power converter 41. The rotor 14 is fixed to the rotating shaft 13. The stator 15 is provided around the outer periphery of the rotor 14 via a predetermined gap therebetween. The positive electrode side bus 25 connected to the positive electrode of the DC power source 24 is connected to the neutral point (43) at which the terminals of the three-phase windings 19u, 19v and 19w are collected which are arranged in slots formed in the stator 15. The power converter 41 performs the control by which current from the DC power source 24 is converted to three-phase alternating current which flows to the three-phase windings is 19u, 19v and 19w.

In the motor 40 which increases voltage of the DC power source 24 by using the neutral point (43), the outer housing 18 is fixed to the outer periphery of stator 15 via the insulating layer 17, the neutral point (43) is connected to the stator 15 by wiring instead of the positive electrode side bus 25, and the stator 15 is connected to the positive electrode side bus 25 by wiring.

According to the above configuration, when the three-phase alternating current converted in the power converter 41 flows to the three-phase windings 19u, 19v and 19w, the leak current Ik1 flows from the three-phase windings 19u, 19v and 19w to the stator 15 via stray capacitance between the three-phase windings 19u, 19v and 19w and the stator 15. The flowing leak current Ik is divided into the leak current Ik1 and the leak current Ik2. The leak current Ik1 flows from the stator 15 to the outer housing 18 via the insulating layer 17. The leak current Ik2 flows from the stator 15 to the positive electrode side bus 25.

The large leak current Ik2, which flows from the stator 15 to the positive electrode side bus 25, flows from the DC power source 24 to the three-phase windings 19u, 19v and 19w via the power converter 41. That is, the leak current Ik2 does not flow to the outer housing 18 of the motor 40. Meanwhile, since the insulating layer 17 intervenes between the stator 15 and the outer housing 18, the leak current Ik1, which can flow from the stator 15 to the outer housing 18 via the insulating layer 17, does not flow or slightly flows. Therefore, the current leaking from the outer housing 18 to the ground, i.e. the common mode current, is reduced so as to become extremely small or not to flow. In addition, the motor 40 according to the present embodiment does not require additional components such as a noise reduction circuit which is installed in conventional motors, which prevents the motor 40 including the power converter 41 from increasing in size and complicating the control thereof. Note that the present invention can be applied to any polyphase motors as well as the three-phase motors described in the above first and second embodiments.

Hereinafter, aspects of the above-described embodiments will be summarized.

The above embodiments provide, as one aspect, a motor including a rotor fixed to a rotating shaft, a stator provided around the outer periphery of the rotor via a gap, and a power converter which is connected to polyphase windings arranged in slots formed in the stator, and performs control by which current from a DC power source is converted to polyphase alternating current which flows to the polyphase windings, including: a housing which is fixed to the outer periphery of the stator via an insulating layer, wherein the stator is connected to a positive electrode side bus, which is connected to a positive electrode of the DC power source, or a negative electrode side bus, which is connected to a negative electrode of the DC power source.

According to the above configuration, when the polyphase alternating current converted in the power converter flows to the polyphase windings, leak current flows from the polyphase windings to the stator via stray capacitance between the polyphase windings and the stator. The flowing leak current is divided into first leak current and second leak current. The first leak current flows from the stator to the outer housing via the insulating layer. The second leak current flows from the stator to the positive electrode side bus (or the negative electrode side bus) of the power converter via the wiring.

The large second leak current, which flows from the stator to the power converter via the wiring, flows from the power converter to the polyphase windings. Alternatively, the second leak current flows from the power converter to the polyphase windings via the DC power source. That is, the second leak current does not flow to the outer housing of the motor. Meanwhile, since the insulating layer intervenes between the stator and the outer housing, the first leak current, which can flow from the stator to the outer housing via the insulating layer, does not flow or slightly flows. Therefore, the current leaking from the outer housing to the ground, i.e. the common mode current, is reduced so as to become extremely small or not to flow. In addition, the motor according to the present embodiment does not require additional components such as a noise reduction circuit which is installed in conventional motors, which prevents the motor including the power converter from increasing in size and complicating the control thereof.

The above embodiments provide, as another aspect, a motor including a rotor fixed to a rotating shaft, a stator provided around the outer periphery of the rotor via a gap, and a positive electrode side bus connected to a positive electrode of a DC power source and connected to a neutral point at which terminals of polyphase windings are collected which are arranged in slots formed in the stator, and a power converter which performs control by which current from the DC power source is converted to polyphase alternating current which flows to the polyphase windings, including: a housing which is fixed to the outer periphery of the stator via an insulating layer, wherein the neutral point is connected to the stator, and the stator is connected the positive electrode side bus.

According to the above configuration, in the motor which increases voltage of the DC power source by using the neutral point, when the polyphase alternating current converted in the power converter flows to the polyphase windings, leak current flows from the polyphase windings to the stator via stray capacitance between the polyphase windings and the stator. The flowing leak current is divided into first leak current and second leak current. The first leak current flows from the stator to the outer housing via the insulating layer. The second leak current flows from the stator to the positive electrode side bus.

The large second leak current, which flows from the stator to the positive electrode side bus, flows from the DC power source to the polyphase windings via the power converter. That is, the second leak current does not flow to the outer housing of the motor. Meanwhile, since the insulating layer intervenes between the stator and the outer housing, the first leak current, which can flow from the stator to the outer housing via the insulating layer, does not flow or slightly flows. Therefore, the current leaking from the outer housing to the ground, i.e. the common mode current, is reduced so as to become extremely small or not to flow. In addition, the motor according to the present embodiment does not require additional components such as a noise reduction circuit which is installed in conventional motors, which prevents the motor including the power converter from increasing in size and complicating the control thereof.

It will be appreciated that the present invention is not limited to the configurations described above, but any and all modifications, variations or equivalents, which may occur to those who are skilled in the art, should be considered to fall within the scope of the present invention.

What is claimed is:

1. A motor including a rotor fixed to a rotating shaft, a stator provided around the outer periphery of the rotor via a gap, and a power converter which is connected to polyphase windings arranged in slots formed in the stator, and performs control by which current from a DC power source is converted to polyphase alternating current which flows to the polyphase windings, comprising:
a housing which is fixed to the outer periphery of the stator via an insulating layer, wherein
the stator is connected to a positive electrode side bus, which is connected to a positive electrode of the DC power source, or a negative electrode side bus, which is connected to a negative electrode of the DC power source.

2. The motor according claim 1, wherein the polyphase windings are three-phase windings.

3. A motor including a rotor fixed to a rotating shaft, a stator provided around the outer periphery of the rotor via a gap, and a positive electrode side bus connected to a positive electrode of a DC power source and connected to a neutral point at which terminals of polyphase windings are collected which are arranged in slots formed in the stator, and a power converter which performs control by which current from the DC power source is converted to polyphase alternating current which flows to the polyphase windings, comprising:
a housing which is fixed to the outer periphery of the stator via an insulating layer, wherein
the neutral point is connected to the stator, and the stator is connected the positive electrode side bus.

4. The motor according claim 3, wherein the polyphase windings are three-phase windings.
